(19) United States
(12) Patent Application Publication
(10) Pub. No.: US 2003/0133681 A1
(43) Pub. Date: Jul. 17, 2003

(54) Light localization structures for guiding electromagnetic waves

(76) Inventor: Sergey Bozhevolnyi, Aalborg (DK)

Correspondence Address: BIRCH STEWART KOLASCH & BIRCH, PO BOX 747, FALLS CHURCH, VA, 22040-0747, US

(21) Appl. No.: 10/338,746

(22) Filed: Jan. 9, 2003

Related U.S. Application Data
(60) Provisional application No. 60/346,298, filed on Jan. 9, 2002.

(30) Foreign Application Priority Data
Jan. 9, 2002 (DK) PA 2002 00030

(51) Int. Cl. G02B 6/10; G02B 6/26

(52) U.S. Cl. 385/129; 385/50

(57) ABSTRACT

The invention provides a waveguiding device and a method for guiding electromagnetic (EM) waves, in particular surface plasmon polaritons (SPPs), using strongly scattering random media exhibiting light localization. Also, the invention provides a cavity for providing resonance conditions for EM waves, in particular surface plasmon polaritons using strongly scattering random media exhibiting light localization. In a strongly scattering random medium with a high enough density of scatterers (so that the average distance between scatterers is smaller than the wavelength), EM waves can only exist in localized modes and can therefore not propagate. By forming regions free from scatterers in the regions with randomly distributed scatterers, the localization effects in scattering media can be utilized to guide propagating modes in these regions. The invention can be used to form compact integrated optical components and circuits.

This application claims the benefit of U.S. Provisional application No. 60/346,298 filed on Jan. 9, 2002.

### FIELD OF THE INVENTION

The present invention relates to a device for guiding electromagnetic waves, in particular surface plasmon polaritons (SPPs), using strongly scattering random media exhibiting light localization and containing regions free from scatterers. Furthermore, the present invention relates to a method for controlling the propagation of electromagnetic waves by means of such a device.

### BACKGROUND OF THE INVENTION

Multiple elastic scattering of light in random media can result in light localization if the elastic scattering mean free path decreases below the wavelength of light. When a wave propagates through a strongly scattering and non-absorbing random medium, the mean free path is reduced due to interference of waves scattered along the same path in opposite directions. With the increase of scattering, this interference eventually brings radiation transport to a complete halt, and propagation no longer exists—the wave is localized.

The existence of light localization has been reported by Wiersma et al., Nature, 390, 671 (1997). The article describes the measurements of the transmission of light at the wavelength of 1064 nm by samples made of gallium arsenide (GaAs) powders with different average particle diameters. When the particle size decreases to the average value of 300 nm, the transmission coefficient is shown to decrease exponentially with the sample thickness, which is the signature of light localization. In this case, the characteristic length scale of the exponential decay, i.e., the localization length, is found to be 4.3 μm.

Localization of light is expected to occur when the elastic scattering mean free path is smaller than the wavelength of light. On the other hand, the increase in the wavelength results eventually in the decrease of the scattering cross section and, thereby, in the increase of the scattering free path. This means that the phenomenon of light localization can be realized in a limited range of wavelengths, which can be rather broad for sufficiently strong scattering media.

Surface plasmon polaritons (SPPS) are electromagnetic excitations propagating along an interface between a metal and a dielectric. If two metal interfaces are close to each other, e.g., when a thin metal film is sandwiched between two dielectric media, SPPs existing at each of two interfaces become coupled resulting in the formation of two SPP-modes, one of which has larger loss (and shorter propagation length) than the SPP at an individual interface and is called short-range SPP. Another one has smaller loss (and longer propagation length) than the SPP at an individual interface and is called long-range SPP (LR-SPP). For practical usage, the latter one, viz., the LR-SPP, is of the main interest.

In ‘Waveguiding in Surface Plasmon Polariton Band Gap Structures’, Phys. Rev. Lett., 86, 3008 (2001), by S. I. Bozhevolnyi et al. shows direct observations (with a near-field optical microscope) of Surface. Plasmon Polariton Band Gap (SPPBG) structures and SPP guiding along line defects in SPPBG structures. The SPPs are prohibited from propagation in areas having periodically arranged surface scatterers, and thereby the propagation of the SPPs is confined to areas being substantially void of such periodically arranged scatterers. A similar device is described in ‘Observation of propagation of surface plasmon polaritons along line defects in a periodically corrugated metal surface’, Optics Letters, 26, 734 (2001), by S. I. Bozhevolnyi, et al. SPPBG waveguides are adapted to guide SPPs within a narrow range of wavelengths, i.e. electromagnetic waves having substantially different wavelengths may not be guided simultaneously.

The phenomenon of SPP localization by elastic scattering on randomly located surface scatterers (surface roughness) has been investigated by Bozhevolnyi et al. in Phys. Rev. B, 54, 8177 (1996) and Opt. Com. 117, 417 (1995). These articles describe direct observations (with a near-field optical microscope) of SPP localization at the wavelength of 633 nm on the randomly rough surface of gold film.

A number of articles describe elastic scattering on artificial surface structures and utilization thereof, these are Bozhevolnyi et al. Phys. Rev. B, 58, 10899, 1998 and Phys. Rev. Lett. 78, 2823, (1997). Different microcomponents for SPPs, straight, curved and corner-square micromirrors, are created by fabricating specially designed configurations of individual microscatterers.

Photonic band gap (PBG or SPPBG) materials have been used to inhibit the propagation of light (or SPPs) within a relatively narrow range of wavelengths (wavelengths within the band gap). The PBG effect relies on multiple scattering in media with periodic variations of the dielectric constant. The PBG is centered at the wavelength determined by the period of dielectric constant modulation. It is known how to control the propagation of electromagnetic waves by means of a device having surface scatterers arranged periodically to form PBG or SPPBG regions in order to inhibit the propagation within these areas.

It is a disadvantage of PBG and SPPBG devices that they function effectively only within a narrow wavelength interval around the wavelength determined by the periodical modulation.

### SUMMARY OF THE INVENTION

It is an object of the present invention to provide a waveguiding device for controlling the propagation of electromagnetic waves, such as by guiding in a waveguide or by providing resonance conditions in a cavity, in particular surface plasmon polaritons, the waveguiding device being adapted to simultaneously control the propagation of electromagnetic waves within a broad range of wavelengths.

It is a further object to provide a waveguiding device for controlling the propagation of electromagnetic waves, such as by guiding in a waveguide or by providing resonance conditions in a cavity, which is adapted to change the direction of the electromagnetic waves substantially within a very short path length.

It is an even further object to provide a method for controlling the propagation of electromagnetic waves in such a way that the control is achieved for a broad range of wavelengths of the electromagnetic waves.

According to a first aspect of the present invention there is disclosed a waveguiding device for guiding electromagnetic waves, said waveguiding device comprising:

a first medium having first regions with randomly varying dielectric constant, ε, said variation being sufficiently strong and taking place on sufficiently small scale to form a plurality of randomly distributed scatterers for scattering the electromagnetic waves and having an average distance preventing said electromagnetic waves from propagating in said first regions,

one or more second regions of said first medium in which variations of the dielectric constant, ε, is either non-existing or significantly smaller and/or taking place on a significantly larger scale than the variations taking place in said first regions, so as to allow said electromagnetic waves to propagate in said one or more second regions said one or more second regions being at least partially surrounded by the first regions, the one or more second regions thereby forming one or more channels for guiding the electromagnetic waves through the first regions.

According to a second aspect of the present invention there is provided a method of guiding electromagnetic waves, said method comprising the steps of:

providing a first medium having first regions with a randomly varying dielectric constant, ε, said variation being sufficiently strong and taking place on sufficiently small scale to form a plurality of randomly distributed scatterers for scattering the electromagnetic waves and having an average distance preventing said electromagnetic waves from propagating in said first medium,

providing one or more second regions of said first medium in which variations of the dielectric constant, ε, is either non-existing or significantly smaller and/or taking place on a significantly larger scale than the variations taking place in said first regions so as to allow said electromagnetic waves to propagate in said second regions, said one or more second regions being at least partially surrounded by the first regions, the one or more second regions thereby forming one or more channels for guiding the electromagnetic waves through the first regions, and

guiding electromagnetic waves in at least one of said channels.

According to a third aspect of the present invention there is provided a cavity supporting resonance of electromagnetic waves, said cavity comprising:

a first medium having a first region with randomly varying dielectric constant, ε, said variation being sufficiently strong and taking place on sufficiently small scale to form a plurality of randomly distributed scatterers for scattering the electromagnetic waves and having an average distance preventing said electromagnetic waves from propagating in said first regions,

a second region of said first medium in which variations of the dielectric constant, ε, is either non-existing or significantly smaller and/or takes place on a significantly larger scale than the variations taking place in said first region,

wherein said second region is at least partially surrounded by the first region so that the second region form a cavity for supporting resonance of electromagnetic waves in the first region, and wherein the variations of the dielectric constant in the second region allows the electromagnetic waves to form standing and/or circulating waves in the cavity.

According to a fourth aspect of the present invention there is provided a device for interconnection of optical channels carrying electromagnetic waves, the device comprising:

at least one first waveguide for guiding electromagnetic waves,

at least one second waveguide for guiding electromagnetic waves,

at least one optical component comprising a waveguide and/or a cavity according to the first and/or third aspect of the invention,

wherein the at least one optical component is positioned between the first and the second channels, so that electromagnetic waves may be lead to and from said component(s) by means of the first and second channels.

It is known that light incident on a strong scattering and non-absorbing random medium is reflected, because the light cannot propagate (i.e., only localized modes exist) in such a medium. The same phenomenon is known to exist also for SPPs propagating along metal surfaces with random roughness, e.g., with randomly located microscatterers. In order to realize the light localization (LL), in particular the SPP localization (SPPL), the elastic scattering mean free path for electromagnetic waves should be much smaller than the light (SPP) propagation length and of the order of the light (SPP) wavelength or smaller. This means that the average size of microscatterers and their average separation should be sufficiently small, approaching the order of the wavelength or smaller. In the regime of the LL (SPPL), it is expected that the light (SPP) will propagate only in the regions that are left free of (random) microscatterers. Thereby, the localization can be used to perform guiding of non-localized, i.e., propagating, modes in channels in these structured regions. In this way the wave guiding along channels in the LL/SPPL areas (areas with random variations of the dielectric constant) can be realized similar to the wave guiding along channels in periodic media exhibiting PBG/SPPBG effect (periodically corrugated areas). However, in the case of channels in the LL/SPPL structures, it is expected that the wave guiding can be achieved in a considerably broader range of the wavelengths.

Therefore, photonic components based on the LL/SPPL structures can be advantageously used in the applications requiring a broad spectral response, e.g., for guiding radiation containing many wavelengths (in WDM circuits) towards a dispersive component responsible for separation of different channels. LL/SPPL structures are expected to be ultra-compact since there is no fundamental limit on the bend angle of channel waveguides in the LL/SPPL structures, enabling one to realize ultra-compact Y-junctions, beam splitters, Mach-Zender interferometers that can be used for routing of light and sensor applications. Usage of materials whose dielectric properties can be modified with external perturbations, e.g., electro-optic crystals or polymers, (for SPPL structures, these can be placed on one or both sides of metal films) opens up the possibility of realizing ultra-compact active devices (e.g., switches and/or modulators) that can operate in a broad wavelength range. At the same time, the localized states appearing at the borders of the LL/SPPL structures, which are expected to be localized on the sub-wavelength scale creating large intensities of electromagnetic field, should be wavelength dependent and, thereby, can be used for wavelength selective sensing, e.g. for single molecule (fluorescence) detection. Another possibility is to use these localized states for coupling (a part of) the radiation out of the structure (e.g., by bringing a fiber probe close to the spatial location of the localized state). Since the location of these states is expected to be wavelength dependent, such an out-coupling of light (SPP) would be performing also the wavelength division function.

In the first aspect, the first regions with scattering random media will prevent the radiation from propagation in specific directions. However, depending on the geometry of the embodiment, the first regions may be connected to form different parts of one single larger first region. Also, the channel will typically have two open ends which are not terminated by first regions with scattering random media. The waveguide will lead from one side of the first region(s) to another, and radiation can be coupled to the waveguide through the open ends (e.g. by butt-coupling). In specific embodiments, this may not be necessary. For example, in SPP waveguides according to the invention, radiation may be coupled to a channel with no open ends using the Kretschmann configuration.

The first regions have a randomly varying dielectric constant, ε, as opposed to the periodic structure of scatterers known from the prior art. This is a great advantage since the randomly varying dielectric constant, ε, is expected to prohibit the propagation of electromagnetic waves within a broad range of wavelengths, and thereby to confine the propagation of these electromagnetic waves to the second region(s). Thereby the waveguiding device is adapted to simultaneously guide electromagnetic waves having substantially different wavelengths.

In case the second regions form more than one channel, and the channels are mutually interconnected, the waveguiding device may also function to either split or combine beams of electromagnetic waves, and/or to change the direction of all or some of a beam of electromagnetic waves.

One of the channels may be split into two channels (arms) that are subsequently combined into one (output) channel forming an interferometer (of Mach-Zender type). Subjecting one of the arms to an external perturbation (e.g. temperature, pressure, electric or magnetic field) can result in the variation of the intensity of electromagnetic waves in the output channel. This effect can be used for fabrication of compact sensors (of the external perturbation) and modulators of the light power.

One of the channels may further be used for guiding radiation containing various wavelengths towards a wavelength selective optical element, whereas other channels may be used to guide the electromagnetic waves with specific wavelengths or having specific wavelength ranges from that element towards, e.g., optical fibers. This configuration can be used for making a compact wavelength division multiplexer/demultiplexer.

The variations of the dielectric constant, ε, may be provided by particles each having a dielectric constant, ε, whose variations across the particle are significantly smaller than the average dielectric constant of the particle.

In this case the average dielectric constant, ε, of at least one scatterer in the propagation prohibiting part(s) of the first medium may be significantly different from the dielectric constant of the medium surrounding said scatterer(s). Thus, when such scatterers are embedded in a medium having a substantially homogeneous value of the dielectric constant, they inherently provide substantial variations of the dielectric constant of the medium, seen as a whole.

The variations of the dielectric constant, ε, is preferably the order of magnitude of the average value of ε in the first medium. Thus, the variations of ε are preferably relatively large/strong compared to the average value of ε in order to prevent the electromagnetic waves from propagating in the first medium.

The ability to prohibit propagation of electromagnetic waves in the first medium, and the ability to allow propagation of electromagnetic waves in the second regions, are preferably substantially independent of the wavelength of the electromagnetic waves, at least within a certain range of wavelengths. Thus, the waveguiding device is preferably adapted to guide electromagnetic waves, substantially regardless of their wavelength.

Also, the distances between the scatterers (such as between the centers of scatterers) may be randomly distributed, thereby providing random variations of the dielectric constant, ε. The average distance between the scatterers in the propagation-prohibiting part(s) are preferably of the order of magnitude of λ or smaller, where λ is a typical wavelength of the electromagnetic waves being guided by the waveguiding device.

Thus, the variations of the dielectric constant, ε, preferably takes place on a very small scale. If it is desired to guide electromagnetic waves having a short wavelength, it should accordingly be ensured that the variations take place on a sufficiently small scale. However, electromagnetic waves having longer wavelengths may also be guided by such a waveguiding device, at least within a broad range of wavelengths.

The transverse dimensions of the channels should be large enough to support a propagating mode of the electromagnetic radiation. To this respect, the smallest transverse dimensions of the one or more channels are preferably larger than the average distance between scatterers. Preferably, the smallest transverse dimensions of the one or more channels are larger than two times the average distance between scatterers, such as three times the average distance between scatterers, or five times the average distance between scatterers.

The sizes of the scatterers may be randomly distributed. This, also, contributes to random variations of the dielectric constant, ε. The average size of the scatterers are preferably of the order of magnitude of λ or smaller, where λ is a typical wavelength of the electromagnetic waves being guided by the waveguiding device. Thus, the average size of the scatterers is preferably very small, rendering a sufficiently small average distance between the scatterers possible.

In a preferred embodiment the second regions of the first medium allows propagation of electromagnetic waves having a wavelength at least in a certain range of wavelengths. In this embodiment the waveguiding device is adapted to guide electromagnetic waves of various wavelengths, i.e. the ability to guide an electromagnetic wave is substantially independent of the wavelength of the electromagnetic wave, at least in a certain range of wavelengths. In case the range of wavelengths is relatively large, the waveguiding device is, for all practical purposes, capable of guiding electromagnetic waves having any desired wavelength.

In a preferred embodiment the electromagnetic waves represent surface plasmon polaritons (SPPs), in which case the waveguiding device further comprises:

at least one second medium forming at least one interface with the first medium, said interface(s) being adapted to guide surface plasmon polaritons and being at least substantially plane.

Preferably, one of the media is a dielectric and the other is a metal, since a dielectric/metal interface is well suited for guiding SPPs.

The second regions allowing the propagation of the electromagnetic wave may, in this case, be confined to the at least one interface. This is practical since SPPs propagate along an interface. Alternatively, the second regions may be positioned around the interface(s) in such a way that a part of the interface(s) is comprised in the second regions, but adjacent parts of the first medium are also included.

The at least one second medium may comprise at least one thin conducting film being supported by the first medium. In this case the film forms at least two interfaces with the first medium, corresponding to the two surfaces of the film. SPPs may propagate along one or both/all of these interfaces.

The waveguiding device may further comprise:

at least one third medium forming at least one interface with the first medium and/or the at least one second medium, said interface(s) being adapted to guide surface plasmon polaritons and being at least substantially plane.

The second and third media may be positioned in such a way that they each form one or more interface(s) with the first medium, but do not form interfaces with each other. Alternatively, they may be positioned in such a way that they form at least one interface with each other. They may, e.g., be positioned in a sandwich structure, where a layer of the second medium adjacent a layer of the third medium are embedded in the first medium, or alternating layers of the second and third media may be embedded in the first medium in such a way that only the outermost layers form interfaces with the first medium. The purpose of the third medium is to provide both short and long range SPPs as described previously.

Thus, the at least one third medium may comprise at least one thin conducting film being supported by the first medium and/or by the at least one second medium.

The first medium may have a first dielectric constant, ε₁, having a positive real part, Re(ε₁)>0, in a first wavelength range, and the at least one second medium may have a second dielectric constant, ε₂, having a negative real part, Re(ε₂)<0, in a second wavelength range, said first wavelength range as well as said second wavelength range comprising a range of wavelengths in which it is desired to guide electromagnetic waves by means of the waveguiding device. Thus, the first medium is preferably a dielectric, and the second medium is preferably a conducting material, e.g. a metal. The waveguiding device will in this case be adapted to guide electromagnetic waves having wavelengths within the range covered by the first wavelength range as well as the second wavelength range.

Additionally to forming one or more channels, at least one of the second regions may form a cavity at least partly surrounded by the first regions, said cavity being adapted to support standing and/or circulating electromagnetic waves corresponding to the electromagnetic waves being guided by the waveguiding device.

The second regions may be at least substantially void of variations of the dielectric constant, ε. Thus, the region(s) may have a substantially uniform dielectric constant, ε.

As mentioned above, according to the second aspect of the invention there is provided a method of guiding electromagnetic waves.

The method may further comprise the step of forming the scatterers by means of embedding particles, said particles having dielectric constants whose variations across the particles are significantly smaller than the average dielectric constants of the particles, in a medium, said medium having a dielectric constant, ε, whose variations across the medium are significantly smaller than the average dielectric constant of the medium.

Alternatively, the scatterers are formed by depositing material on the surface of the first medium in a random pattern. Electromagnetic waves having a field with an amplitude outside the first medium (as is the case for SPPs) will feel the presence of such deposited material making the deposited material act as scatterers.

Thus, the scatterers are preferably particles of a material having a dielectric constant which is significantly different from the dielectric constant of the first medium. However, the dielectric constant of the first medium and of the particles do not vary. The variations are, thus, provided by the presence of the particles. The particles may all be made from the same material, or they may be made from a variety of materials, all having different dielectric constants, as long as the dielectric constant of each material is significantly different from the dielectric constant of the first medium.

The average dielectric constant of at least one scatterer in the propagation-prohibiting part(s) of the first medium may be significantly different from the dielectric constant of the medium surrounding said scatterer(s), thereby providing the variations of the dielectric constant.

The sizes of the scatterers may be randomly distributed, and/or the step of forming a plurality of scatterers may be performed in such a way that the distance between the scatterers is randomly distributed, and/or the step of forming a plurality of scatterers may be performed by forming scatterers having an average size of the order of magnitude of λ or less, where λ is a typical wavelength of the propagating electromagnetic waves, in order to provide suitable variations of the dielectric constant.

The electromagnetic waves may represent surface plasmon polaritons (SPPs), the method further comprising the step of:

providing at least one second medium forming at least one interface with the first medium, said interface(s) being adapted to guide surface plasmon polaritons and being at least substantially plane.

The method may further comprise the step of confining the second regions to the at least one interface, so that propagation of the electromagnetic waves is confined to the at least one interface.

Alternatively or additionally, the method may further comprise the step of:

providing at least one third medium forming at least one interface with the first medium and/or the at least one second medium, said interface(s) being adapted to guide surface plasmon polaritons and being at least substantially plane.

Additionally to forming at least one channel for guiding the electromagnetic waves, the step of providing the second regions may comprise forming at least one cavity being at least partly surrounded by the first regions of the first medium, said cavity being adapted to support standing and/or circulating electromagnetic waves corresponding to the propagating electromagnetic waves.

As mentioned above, according to the third aspect of the present invention there is provided a cavity supporting resonance of electromagnetic waves.

As for the first aspect, the distances between the scatterers in the first region are preferably randomly distributed with the average distance of the order of magnitude of λ or smaller, where λ is a typical wavelength of the electromagnetic waves.

The dimensions of the cavity should large enough to support standing and/or circulating electromagnetic waves. The second region forming the cavity should by be formed with the intention to form a cavity and should not be a result of the randomized distribution of scatterers. Thus, the property of supporting resonance conditions in a second region is introduced artificially as opposed to a small part of a first region supporting resonance conditions by coincidence. To this respect, the smallest dimensions of the cavity is preferably larger than the average distance between scatterers. Preferably, the smallest transverse dimensions of the cavity is larger than two times the average distance between scatterers, such as three times the average distance between scatterers, or five times the average distance between scatterers.

Generally speaking, a localized mode in the first region with scattering random media is an evanescent field decaying exponentially in all directions. Standing waves have constant average field strength inside the cavity and decays as evanescent fields only outside the cavity borders. Thus, in order to couple radiation in and/or out of the cavity, a further second region is preferably positioned so close to the cavity that the evanescent fields can couple to modes in the further second regions. The further second region is separated from the cavity by a barrier consisting of a first region with scattering random media. The width of this barrier in relation to the exponential decay of the evanescent field determines the transmission of the “coupling mirror” of the cavity. Typically, the further second region is a waveguide according to the first aspect of the invention. Alternatively, the further second region is another cavity according to the third aspect, thereby forming a series of coupled cavities.

As mentioned above, according to the fourth aspect of the present invention there is provided a device for interconnection of optical channels carrying electromagnetic waves.

The at least one first channel or the at least one second channel preferably functions as input channel(s) for leading electromagnetic waves to the at least one optical component, and the channel(s) which do not function as input channel(s) preferably function as output channel(s) for leading electromagnetic waves away from the at least one optical component.

The at least one first channel may be adapted to lead electromagnetic waves to the at least one optical component, and the at least one second channel may be adapted to lead electromagnetic waves away from the at least one optical component, said at least one second channel having a substantially different direction with respect to said at least one first channel, in such a way that the propagation direction of the electromagnetic waves being guided by the at least one first channel and the at least one second channel is changed.

In this embodiment the optical component(s) function(s) in such a way that the direction of the electromagnetic waves is significantly changed when they pass the optical component(s). The direction of the electromagnetic waves being guided by the second channel(s) may, thus, be, e.g., substantially perpendicular to or substantially opposite to the direction of the electromagnetic waves being guided by the first channel(s), or the direction may be along any other suitable direction.

The device may comprise at least two second channels, wherein the at least two second channels may be adapted to lead electromagnetic waves away from the at least one optical component in such a way that the electromagnetic waves being guided by the at least one first channel are split between the at least two second channels.

In this case the optical component(s) function(s) as a ‘splitter’, splitting up an incoming beam of electromagnetic waves into two or more beams.

Alternatively or additionally, the device may comprise at least two second channels, and the at least two second channels may be adapted to lead electromagnetic waves to the at least one optical component in such a way that the electromagnetic waves being guided by the at least two second channels are combined in the at least one first channel.

In this case the optical component(s) function(s) as a ‘combiner’, combining two or more incoming beams of electromagnetic waves into a smaller number of beams, preferably into a single beam.

The first and the second channels may be connected to optical fibers, so that the device may be connected to other equipment, such as other similar devices, optical components, sources of electromagnetic waves, etc.

In case the device is made from materials whose dielectric properties can be modified with external perturbations, the characteristics of the device may be controlled externally, e.g. by varying the temperature, pressure, electric or magnetic field in the region(s) comprising the at least one channel of the device. For example, one or more of the first, second and third media may be made of electro-optic materials or laminated material compositions forming quantum well structures.

The first, second, and third aspects of the present invention may each be combined with one or more of the other aspects of the present invention.

### BRIEF DESCRIPTION OF THE DRAWING

The invention will now be described with reference to the accompanying drawing in which:

FIG. 1A shows a perspective view of a random medium comprising a channel free from scatterers.

FIG. 1B shows a cross section along the channel direction of the medium of FIG. 1A.

FIG. 2 shows a cross section of a medium comprising a metal film supporting the SPP propagation

FIG. 3A and B are scanning electron microscope (SEM) images of areas containing randomly positioned scatterers densities of ˜37,5 μm⁻² (3A) and ˜50 μm⁻² (3B).

FIG. 4A is a topographical image of 25×25 μm² obtained with the fabricated sample.

FIG. 4B is a near-field optical image corresponding to FIG. 4A, and being taken at a wavelength of 738 nm with an excited SPP propagating upwards.

FIG. 5 is a diagram showing a cross section of the optical intensity of FIG. 4B (upper curve) and of the topographical image of FIG. 4A (lower curve).

FIG. 6. is a SEM image of an area containing randomly positioned scatterers with a density of ˜75 μm⁻².

FIG. 7A is a topographical image of 32×22 μm² obtained with the fabricated sample, and

FIGS. 7B-D are near-field optical images corresponding to FIG. 7A, and being taken at a different wavelengths with an excited SPP propagating upwards.

FIG. 8 is a diagram showing a cross section of the optical intensity of FIG. 7C (upper curve).

FIG. 9 is a diagram showing the dependence of the propagation loss on the wavelength.

FIG. 10A shows a perspective view of a random medium comprising a cavity free from scatterers.

FIG. 10B shows a cross section of the random medium of FIG. 10A.

### DETAILED DESCRIPTION OF THE DRAWING

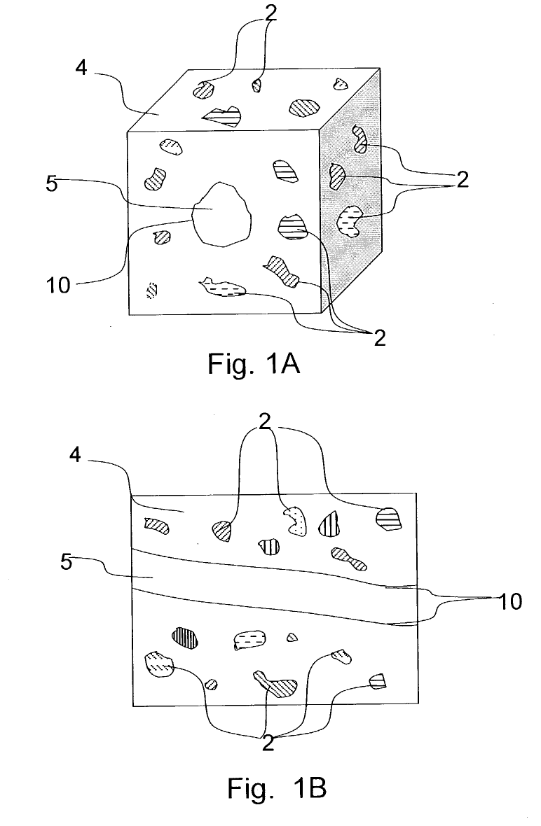

FIGS. 1A and 1B illustrate a medium 4 having a first region with randomly distributed scatterers 2 of various sizes and shapes, and made from various materials. The medium 4 further comprises a second region forming a channel 5 in the medium 4, the channel 5 being substantially free from scatterers 2. A boundary 10 of the channel 5 can be a real physical interface between two materials with substantially different refractive indexes or an imaginary boundary separating the channel region 5 (which is substantially free from scatterers 2) from the medium 4 containing randomly distributed scatterers 2. The channel 5 is adapted to guide electromagnetic waves through the medium 4. Because the scatterers 2 are randomly distributed, of random sizes, shapes and materials, the channel 5 may guide electromagnetic waves within a broad range of wavelengths.

The average dielectric constant, ε, of each of the scatterers 2 is substantially different from the average dielectric constant, ε, of the medium 4, thereby providing a random variation of the dielectric constant, ε, of the medium 4 and scatterers 2 combined.

FIG. 1A is a perspective view of the medium 4, and FIG. 1B is a cross sectional view of the medium 4 along the direction of the channel 5, and through the channel 5.

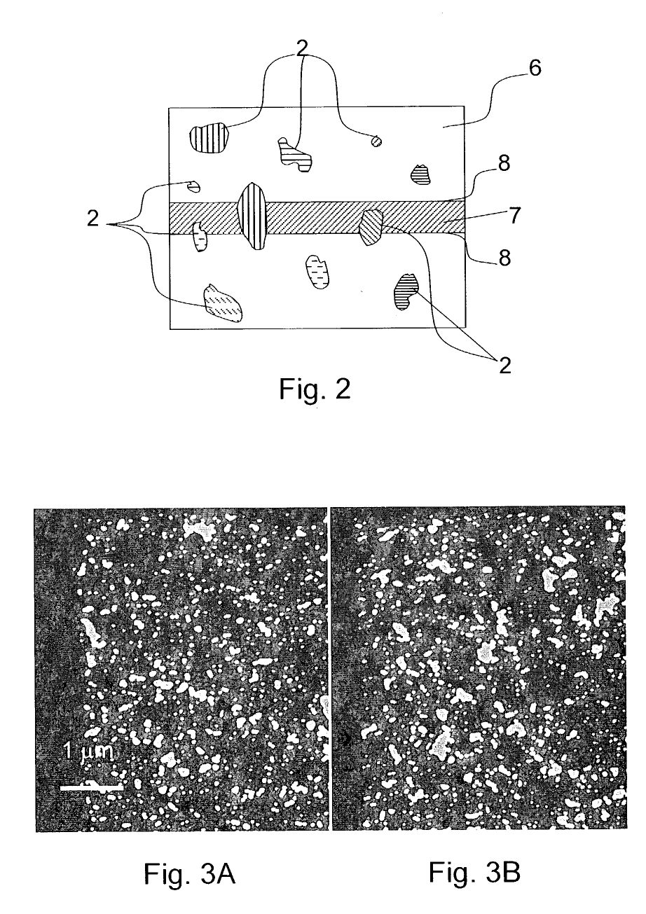

FIG. 2 is a cross sectional view of another medium 6 having randomly distributed scatterers 2 of various sizes and shapes, and made from various materials. The medium 6 further comprises a metal film 7 forming two interfaces 8 with the medium 6. The interfaces 8 are substantially plane and adapted to support SPP propagation. The medium 6 may further comprise regions (not shown) forming channels as described above in connection with FIGS. 1A and 1B for guiding electromagnetic waves. Such regions will, in this case, preferably be confined to one or both of the interfaces 8, so that SPPs may be guided and/or standing SPP waves may be supported along the interface(s) 8. FIGS. 3A and B are scanning electron microscope (SEM) images of interfaces 8 having regions containing randomly distributed scatterers. In these two different samples, the scatterers are ˜50-nm-wide and ˜45-nm-high gold bumps with a nominal density of 37,5 μm⁻² (FIG. 3A) and 50 μm⁻² (FIG. 3B). As is to be expected, there is more clustering in the sample with the higher density.

In the following, specific embodiments of waveguide devices described in relation to FIG. 2 will be described in greater detail. These embodiments are constructed to guide SPPs. Experimental observations of inhibition of SPP penetration into randomly corrugated surface regions and SPP guiding along corrugation free channels in these regions are described. SPPs propagate along a metal-dielectric interface and their electromagnetic fields having the maximum at the interface decay exponentially in the neighbor media. SPPs can thereby be easily scattered by surface features and, e.g., localized by random surface roughness if the SPP scattering in the surface plane is sufficiently strong. Here, instead of using natural surface roughness, we employ specially designed and fabricated random microscatterers to realize strongly localized SPP modes in the corrugated regions allowing SPP propagation only in the corrugation free channels—hence controlled waveguiding.

The observations are carried out on two different samples, N1 and N2.

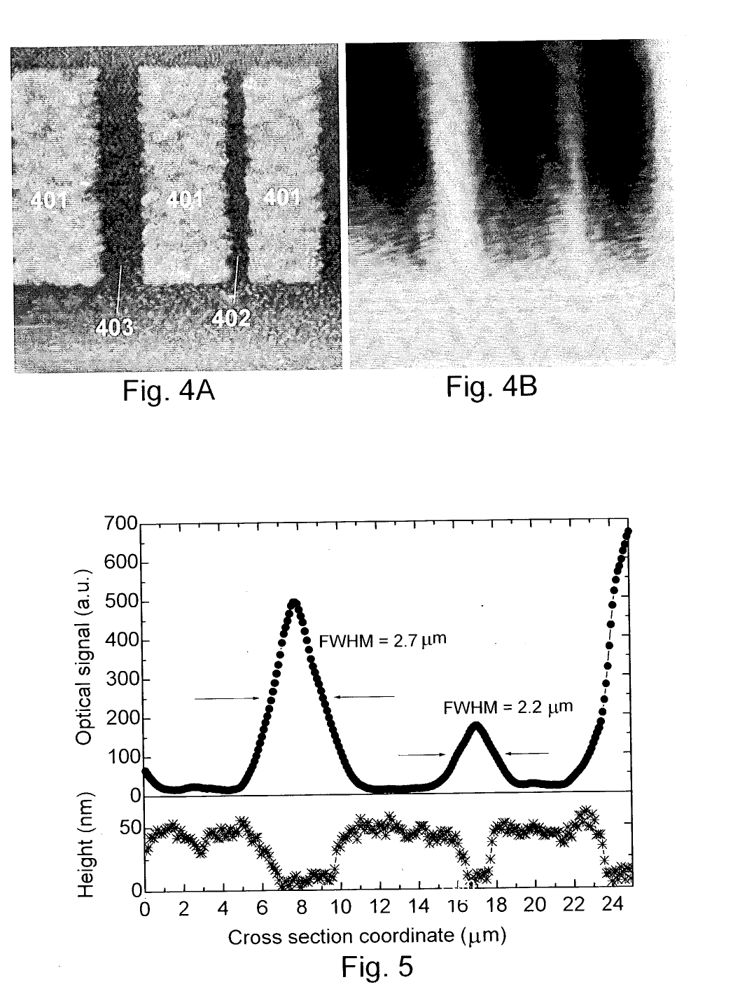

FIG. 4A is a 25×25 μm² topographical image of the fabricated sample N1. A close up of the regions 401 containing randomly distributed scatterers in sample N1 is shown in FIG. 3B. Scatterers are ˜50-nm-wide and ˜45-nm-high gold bumps with a nominal density of 50 μm⁻². The sample has been prepared by evaporating a 45-nm-thick gold film on a glass substrate and covering the film surface with 6×18 μm² rectangular areas filled with the randomly located gold bumps. The latter has been achieved by exposing a resist layer coating the gold film to an electron beam at points whose surface coordinates (within these areas) have been randomly generated. The resist development has been followed by evaporation of a second gold film and liftoff, resulting in random ˜50-nm-wide individual scatterers, arranged often in clusters. The final surface structure contained several areas 401 having the same density and leaving 2 and 4-μm-wide channels 402 and 403 free from scatterers for allowing propagation of SPPs.

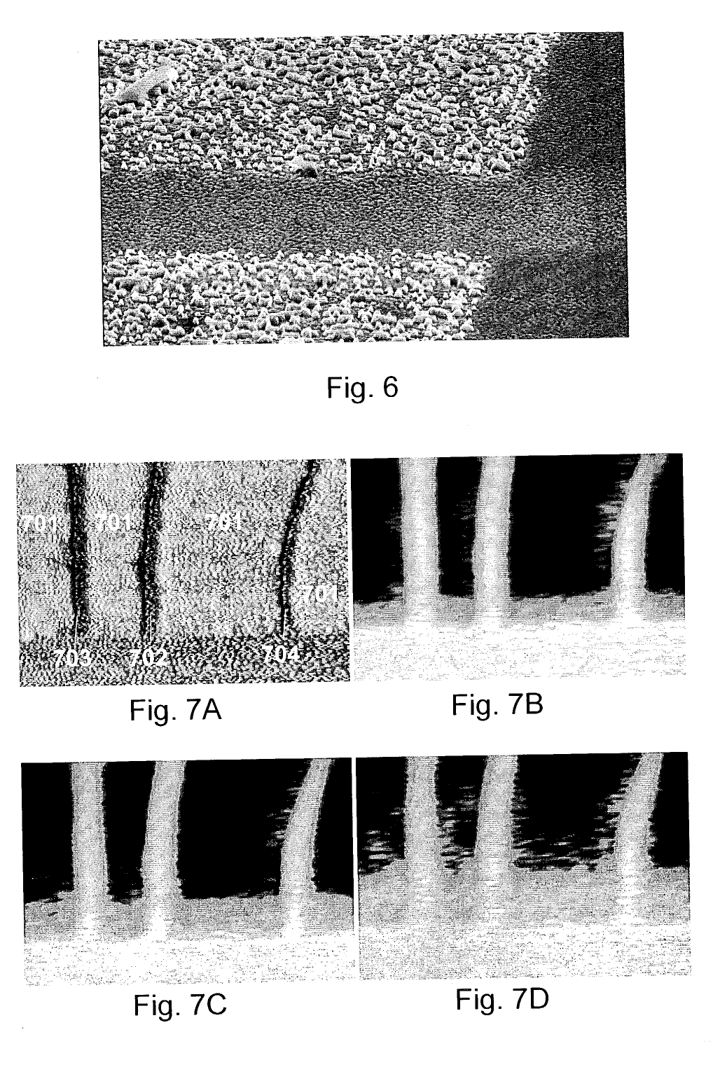

FIG. 7A is a 32×22 μm² topographical image of the fabricated sample N2. A close up of the regions 701 containing randomly distributed scatterers in sample N2 is shown in FIG. 6. Scatterers are ˜70-nm-high gold bumps with a nominal density of 75 μm⁻². Sample N2 has been fabricated using the same procedure as sample N1, but with different parameters. The scattering regions contain three 2-μm-wide channels free from scatterers for allowing the propagation of SPPs. The channels are straight 702, has a 10° bend 703 or a 20° bend 704 (both with a bend radius of 15 μm).

There are several ways of producing scatterers of the corrugated regions. A description of an alternative method of fabrication can be found in e.g. Wiersma et al., Nature, 390, 671 (1997), hereby included by reference.

The experimental setup was essentially the same as that used in similar experiments with SPP band gap structures (S. I. Bozhevolnyi et al., Phys. Rev. Lett. 86, 3008 (2001)). It consists of a scanning near-field optical microscope (SNOM), in which the (near-field) radiation scattered by an uncoated sharp fiber tip into fiber modes is detected, and an arrangement for SPP excitation in the Kretschmann configuration. The p-polarized (electric field is parallel to the plane of incidence) light beam from a Ti:Sapphire laser (λ=725-850 nm, P˜100 mW) is weakly focused (spot size, ˜300 μm) onto the sample attached with immersion oil to the base of a glass prism. The SPP excitation is recognized as a minimum in the angular dependence of the reflected light power. The images retained the appearance up to the tip-surface distance of ˜300 nm with the average signal decreasing exponentially (as expected) with the increase of the distance. It was observed that the field components scattered out of the surface plane were relatively weak, i.e., that the SPP scattering was primarily confined to the surface plane.

For sample N1, the most pronounced effect of SPP guiding along the corrugation free channels was observed in the wavelength range of 725-785 nm. FIG. 4B is a SNOM image obtained at λ≅738 nm and shows a complete damping of the incident SPP inside the randomly structured regions 401 and unhindered SPP propagation along the 4-μm-wide channel 402. The 2-μm-wide channel 403 also supports the SPP propagation even though its excitation efficiency (by the incident plane SPP) is relatively small. The upper graph of FIG. 5 shows the optical image cross section (averaged over a few lines) made at the distance of ˜12 μm from the entrance side and demonstrates well-confined mode intensity distributions for both channels. The lower curve of FIG. 5 shows a cross section of the topographical image of FIG. 4A.

The SPP guiding along channels 402 and 403 and attenuation inside the randomly structured regions 401 gradually deteriorated with the increase of the light wavelength, and at λ≅833 nm the SPP damping became rather weak. Such a wavelength dependence can be accounted for by the fact that the scattering mean free path/increases with the wavelength because of the decrease (for subwavelength-sized scatterers) in the scattering cross section σ(λ) since/˜1/nσ—see e.g. A.V. Shchegrov et al., Phys. Rev. Lett. 78, 4269 (1997). The increase of/leads in turn to an exponential increase of the penetration depth or localization length ξ, ξ˜/exp(2π)/λ), resulting thereby in the decrease of the SPP attenuation in the random structures.

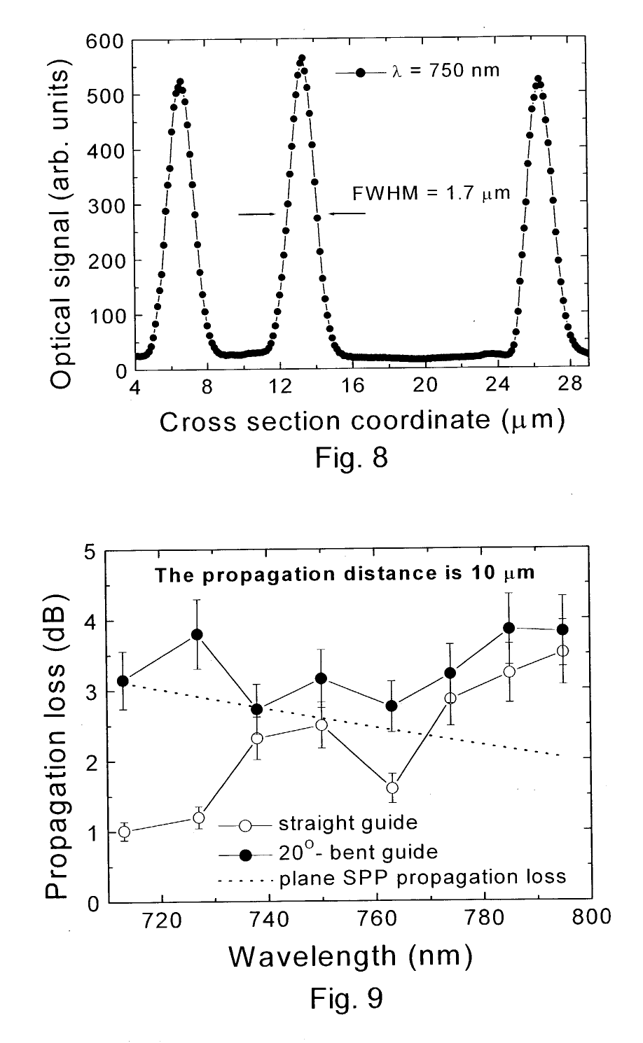

Similar investigations were carried out with sample N2 (having higher scatterers with larger density). The SNOM images of FIGS. 7B-D exhibit quite discernible effects of the SPP attenuation inside the random structures and the SPP guiding along the free channels, both effects being especially pronounced at the wavelengths 713 nm (FIG. 7B), 750 nm (FIG. 7C), and 795 nm (FIG. 7D). The optical image cross section (averaged over a few lines) made before the channel bends for a wavelength of 750 nm shown in FIG. 8 demonstrates well-confined mode intensity distributions with the FWHM of 1.7 μm.

Similarly to the previous case, the SPP guiding along the channels and attenuation inside the random structure deteriorated with the increase of the light wavelength though not so quickly as with sample N1. The observed improvement of the SPP guiding characteristics is attributed to the increase in the scattering cross section (due to the increase in the scatterers' height and density) resulting in the decrease in the scattering mean free path and, thereby, in the localization length.

We have further evaluated the propagation loss (over the distance of 10 μm) in the channels of sample N2 by making the optical image cross sections (averaged over a few lines) before and after the channel bends. The results obtained for the straight and 20°-bent channels are shown in FIG. 9 along with the level of the loss expected for the plane SPP propagating along a smooth (not corrugated) film surface. Note that similarly to the situation with sample N1 the loss for the straight waveguide determined from images obtained in this (particular) near-field experiment can be rather small if the propagation constant (or wavenumber) of the SPP channel mode is sufficiently close to that of the (resonantly excited) plane SPP.

The average cross sections of optical images (obtained at different wavelengths) made along the SPP propagation direction showed that the SPP intensity damping inside the random structures is very close to exponential, especially for short wavelengths. A more thorough description of damping inside regions 601 and its wavelength dependence is given in S. I. Bozhevolnyi et al., Phys. Rev. Lett. 89, 186801 (2002) or S. I. Bozhevolnyi et al. J. Microscopy 210, Pt.3 (2003), hereby included by reference.

Investigating the effects of the density of scatterers shows that the deterioration of the SPP guiding with the increase of the wavelength is more rapid for low density regions than for regions with larger density. By fabricating random structures with larger densities of scatterers and/or larger scatterers (i.e., with larger scattering cross sections), one should be able not only to decrease further the localization length but also to increase the wavelength range in which the SPP guiding is well pronounced.

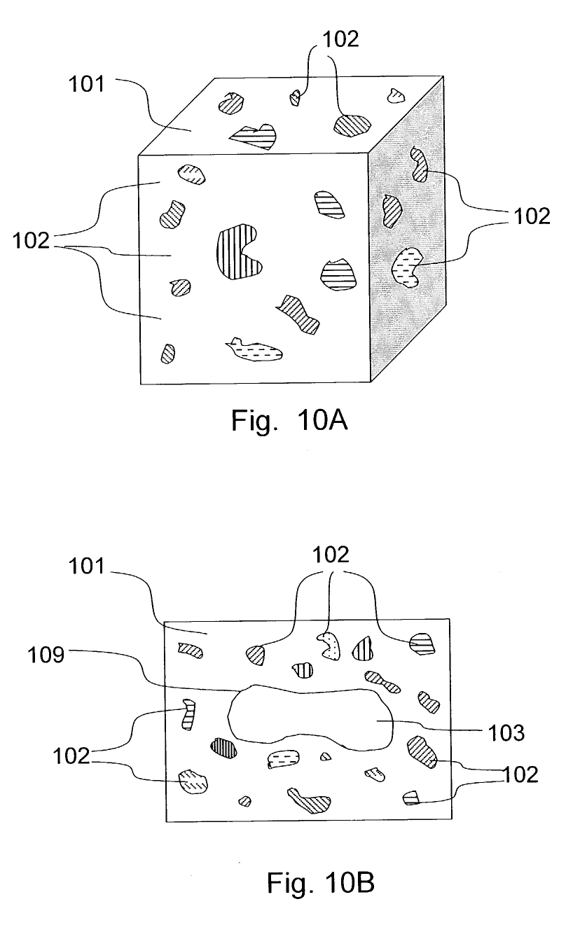

In the following sections, a cavity according to the present invention is described. FIGS. 10A and 10B illustrate a medium 101 having randomly distributed scatterers 102 of various sizes and shapes, and made from various materials. The medium 101 further comprises a region forming a cavity 103 in the medium 101, the cavity 3 being substantially free from scatterers 102. A boundary 109 of the cavity 103 can be a real physical interface between two materials with substantially different refractive indexes or an imaginary boundary separating the cavity region 103 (which is substantially free from scatterers 102) from the medium 101 containing randomly distributed scatterers 102. The cavity 103 is adapted to support standing and/or circulating electromagnetic waves, so that these electromagnetic waves may be trapped inside the medium 101. Because the scatterers 2 are randomly distributed, of random sizes, shapes and materials, the cavity 103 may support standing and/or circulating electromagnetic waves of various wavelengths.

In order to couple radiation into and/or out of the cavity 103, the medium 101 may further comprise channels (not shown) adapted to guide electromagnetic waves to and/or from the cavity 103. These channels may be waveguides as described in relation to FIGS. 1A and B. Alternatively, other types of waveguides may be provided so as to couple radiation into and/or out of the cavity 103. For example, optical fibers may be butt-coupled to a device holding the cavity 103. If the cavity is an SPP cavity, light may be coupled to the cavity using the Kretschmann configuration.

As with the waveguides described in relation to FIGS. 1A and B, the average dielectric constant, ε, of each of the scatterers 102 is substantially different from the average dielectric constant, ε, of the medium 101. Thus, the presence of the scatterers 102 provides a random variation of the dielectric constant, ε, of the medium 101 and scatterers 102, seen as a whole.

FIG. 10A is a perspective view of the medium 101, and FIG. 10B is a cross sectional view of the medium 101 along a plane intersecting the cavity 103.

In a specific embodiment, the cavity is constructed to provide resonance conditions for SPPs. Such cavity can be fabricated using techniques similar to those used to fabricate the waveguides described in relation to FIGS. 4A and 7A.

Thus, according to the present invention there has been provided a waveguiding device for guiding electromagnetic waves which is adapted to simultaneously guide electromagnetic waves within a broad range of wavelengths. Furthermore, the present invention provides a device for guiding electromagnetic waves which is adapted to change the direction of the electromagnetic wave significantly within a very short path length. Even further, the invention provides a method for controlling the propagation of electromagnetic waves, the propagation being achieved for a broad range of wavelengths. Finally, the invention provides a cavity adapted to simultaneously provide internal reflection for electromagnetic waves within a broad range of wavelengths.

1. A waveguiding device for guiding electromagnetic waves, said waveguiding device comprising:
a first medium having first regions with randomly varying dielectric constant, ε, said variation being sufficiently strong and taking place on sufficiently small scale to form a plurality of randomly distributed scatterers for scattering the electromagnetic waves and having an average distance preventing said electromagnetic waves from propagating in said first regions,
one or more second regions of said first medium in which variations of the dielectric constant, ε, is either non-existing or significantly smaller and/or taking place on a significantly larger scale than the variations taking place in said first regions, so as to allow said electromagnetic waves to propagate in said one or more second regions
said one or more second regions being at least partially surrounded by the first regions, the one or more second regions thereby forming one or more channels for guiding the electromagnetic waves through the first regions.

2. A waveguiding device according to claim 1, wherein the scatterers comprises particles each having a dielectric constant, ε, whose variations across the particle are significantly smaller than an average dielectric constant of the particle.

3. A waveguiding device according to claim 1, wherein an average dielectric constant, ε, of at least one scatterer in the first regions of the first medium is significantly different from the dielectric constant of the medium surrounding said scatterer.

4. A waveguiding device according to claim 1, wherein distances between the scatterers in the first regions are randomly distributed with an average distance of the order of magnitude of λ or smaller, where λ is a typical wavelength of the electromagnetic waves being guided by the waveguiding device.

5. A waveguiding device according to claim 1, wherein the smallest transverse dimensions of the one or more channels are larger than an average distance between scatterers.

6. A waveguiding device according to claim 1, wherein the sizes of the scatterers are randomly distributed with an average size of the scatterers of the order of magnitude of λ or smaller, where λ is a typical wavelength of the electromagnetic waves being guided by the waveguiding device.

7. A waveguiding device according to claim 1, wherein the electromagnetic waves represent surface plasmon polaritons (SPPs), the waveguiding device further comprising:
at least one second medium forming at least one interface with the first medium, said interface(s) being adapted to guide surface plasmon polaritons and being at least substantially plane.

8. A waveguiding device according to claim 7, wherein the at least one second region allowing the propagation of the electromagnetic wave is/are confined to the at least one interface.

9. A waveguiding device according to claim 7, wherein the at least one second medium comprises at least one thin conducting film being supported by the first medium.

10. A waveguiding device according to claim 7, further comprising:
at least one third medium forming at least one interface with the first medium and/or the at least one second medium, said interface(s) being adapted to guide surface plasmon polaritons and being at least substantially plane.

11. A waveguiding device according to claim 10, wherein the at least one third medium comprises at least one thin conducting film being supported by the first medium and/or by the at least one second medium.

12. A waveguiding device according to claim 7, wherein the first medium has a first dielectric constant, ε₁, having a positive real part, Re(ε₁)>0, in a first wavelength range, and the at least one second medium has a second dielectric constant, β₂, having a negative real part, Re(ε₂)<0, in a second wavelength range, said first wavelength range as well as said second wavelength range comprising a range of wavelengths in which it is desired to guide electromagnetic waves by means of the waveguiding device.

13. A waveguiding device according to claim 12, further comprising at least one layer of a third medium having a third dielectric constant, ε₃, said layer(s) being positioned at least one of the interface(s), and said layer(s) having thickness(es) which is/are substantially smaller than the wavelength of the electromagnetic waves.

14. A waveguiding device according to claim 1, wherein at least one of the second regions forms a cavity surrounded by the first regions(s) of the first medium, said cavity being adapted to support standing and/or circulating electromagnetic waves corresponding to the electromagnetic waves being guided by the waveguiding device.

15. A waveguiding device according to claim 1, wherein the variations of the dielectric constant, ε, is the order of magnitude of the average value of ε in the first medium.

16. A waveguiding device according to claim 1, wherein the ability to prohibit propagation of electromagnetic waves in the first regions, and the ability to allow propagation of electromagnetic waves in the second regions, are substantially independent of the wavelength of the electromagnetic waves.

17. A waveguiding device according to claim 1, wherein the at least one second region allowing propagation of the electromagnetic waves is at least substantially void of variations of the dielectric constant, ε.

18. A method of guiding electromagnetic waves, said method comprising the steps of:
providing a first medium having first regions with a randomly varying dielectric constant, ε, said variation being sufficiently strong and taking place on sufficiently small scale to form a plurality of randomly distributed scatterers for scattering the electromagnetic waves and having an average distance preventing said electromagnetic waves from propagating in said first medium,
providing one or more second regions of said first medium in which variations of the dielectric constant, ε, is either non-existing or significantly smaller and/or taking place on a significantly larger scale than the variations taking place in said first regions so as to allow said electromagnetic waves to propagate in said second regions, said one or more second regions being at least partially surrounded by the first regions, the one or more second regions thereby forming one or more channels for guiding the electromagnetic waves through the first regions, and
guiding electromagnetic waves in at least one of said channels.

19. A method according to claim 18, further comprising the step of forming the plurality of scatterers of the electromagnetic waves by means of embedding particles, said particles having dielectric constants whose variations across the particles are significantly smaller than average dielectric constants of the particles, in a medium, said medium having a dielectric constant, ε, whose variations across the medium are significantly smaller than an average dielectric constant of the medium.

20. A method according to claim 18, wherein an average dielectric constant of at least one scatterer in the first regions of the first medium is/are significantly different from the dielectric constant of the medium surrounding said scatterer(s).

21. A method according to claim 18, wherein the scatterers are formed with randomly distributed sizes and with an average size of the order of magnitude of λ or less, where λ is a typical wavelength of the propagating electromagnetic waves.

22. A method according to claim 18, wherein the step of forming a plurality of scatterers is performed in such a way that the distances between the scatterers are randomly distributed with the average distance of the order of magnitude of λ or smaller, where λ is a typical wavelength of the electromagnetic waves being guided.

23. A method according to claim 18, wherein the electromagnetic waves represent surface plasmon polaritons (SPPs), the method further comprising the step of:
providing at least one second medium forming at least one interface with the first medium, said interface(s) being adapted to guide surface plasmon polaritons and being at least substantially plane.

24. A method according to claim 23, further comprising the step of confining the one or more second regions to the at least one interface, so that propagation of the electromagnetic waves is confined to the at least one interface.

25. A method according to claim 23, further comprising the step of:
providing at least one third medium forming at least one interface with the first medium and/or the at least one second medium, said interface(s) being adapted to guide surface plasmon polaritons and being at least substantially plane.

26. A method according to claim 18, wherein the step of providing at least one second region of said first medium comprises forming at least one cavity being surrounded by the first regions of the first medium, said cavity being adapted to support standing and/or circulating electromagnetic waves corresponding to the propagating electromagnetic waves.

27. A cavity for supporting resonance of electromagnetic waves, said cavity comprising:
a first medium having a first region with randomly varying dielectric constant, ε, said variation being sufficiently strong and taking place on sufficiently small scale to form a plurality of randomly distributed scatterers for scattering the electromagnetic waves and having an average distance preventing said electromagnetic waves from propagating in said first regions,
a second region of said first medium in which variations of the dielectric constant, ε, is either non-existing or significantly smaller and/or takes place on a significantly larger scale than the variations taking place in said first region,
wherein said second region is at least partially surrounded by the first region so that the second region form a cavity for supporting resonance of electromagnetic waves in the first region, and wherein the variations of the dielectric constant in the second region allows the electromagnetic waves to form standing and/or circulating waves in the cavity.

28. A cavity according to claim 27, wherein distances between the scatterers in the first region are randomly distributed with an average distance of the order of magnitude of λ or smaller, where λ is a typical wavelength of the electromagnetic waves.

29. A cavity according to claim 27, wherein the smallest dimension of the second region forming the interior of the cavity is larger than an average distance between scatterers.

30. A cavity according to claim 27, wherein the first medium further comprises a further second region being separated from the cavity by the first region, the distance between the cavity and the further second region being adjusted to allow coupling of radiation between the cavity and the further second region.

31. A device for interconnection of optical channels carrying electromagnetic waves, the device comprising:
at least one first waveguide for guiding electromagnetic waves,
at least one second waveguide for guiding electromagnetic waves,
at least one optical component comprising a waveguide and/or a cavity according to claim 1 and/or 27,
wherein the at least one optical component is positioned between the first and the second channels, so that electromagnetic waves may be lead to and from said component(s) by means of the first and second channels.

32. A device according to claim 31, wherein the at least one first channel is adapted to lead electromagnetic waves to the at least one optical component, and wherein the at least one second channel is adapted to lead electromagnetic waves away from the at least one optical component, said at least one second channel having a substantially different direction with respect to said at least one first channel, in such a way that the propagation direction of the electromagnetic waves being guided by the at least one first channel and the at least one second channel is changed.

33. A device according to claim 31, the device comprising at least two second channels, wherein the at least two second channels are adapted to lead electromagnetic waves away from the at least one optical component in such a way that the electromagnetic waves being guided by the at least one first channel are split between the at least two second channels.

34. A device according to claim 31, the device comprising at least two second channels, wherein the at least two second channels are adapted to lead electromagnetic waves to the at least one optical component in such a way that the electromagnetic waves being guided by the at least two second channels are combined in the at least one first channel.
